(19) United States
(12) Patent Application Publication
(10) Pub. No.: US 2017/0123760 A1
(43) Pub. Date: May 4, 2017

(54) Code Correction During a User Session in a Distributed Business Transaction

(71) Applicant: AppDynamics, Inc., San Francisco, CA (US)

(72) Inventors: Anthony Kilman, San Francisco, CA (US); Vinay Srinivasaiah, San Carlos, CA (US)

(21) Appl. No.: 14/928,862

(22) Filed: Oct. 30, 2015

(51) Int. Cl. G06F 9/44; G06Q 10/06; H04L 29/08

(52) U.S. Cl. CPC G06F 8/311; H04L 67/10; G06Q 10/0633

(57) ABSTRACT

Distributed business transactions are monitored and problems associated with poor performance are identified. The problems may be associated with a particular portion of code that makes up one or more applications that perform the distributed business transaction being monitored. Portions of code may be replaced to correct the performance issues, by a tool that corrects detected performance issues in a distributed business transaction being monitored. Within a graphical representation, an indicator may be provided that represents a portion of code that is causing poor performance. The present system provides new code which may be used to replace the portion of code that is causing the problem. The retrieved code transmitted from a server to an agent on the machine that is experiencing the issue. The agents may receive the code, compile the code during runtime and replace the portion of code causing the performance issue with the compiled code.

### BACKGROUND

The World Wide Web has expanded to provide numerous web services to consumers. The web services may be provided by a web application which uses multiple services and applications to handle a transaction. The applications may be distributed over several machines, making the topology of the machines that provide the service more difficult to track and monitor.

Monitoring a web application helps to provide insight regarding bottle necks in communication, communication failures and other information regarding performance of the services that provide the web application.

Most application performance monitoring (APM) systems monitor the performance of an application in terms of the time it takes to perform or complete a task. Hence, most APM systems are limited to observing and reporting information about a system being monitored. Unfortunately, providing an administrator with a symptom of a problem does not help the administrator with the problem itself. What is needed is an APM system with more functionality than the typical system monitoring tool.

### SUMMARY

Distributed business transactions are monitored and problems associated with poor performance are identified. The problems may be associated with a particular portion of code that makes up one or more applications that perform the distributed business transaction being monitored. Portions of code may be replaced, semi-automatically or automatically, to correct the performance issues, by a tool that corrects detected performance issues in a distributed business transaction being monitored. A distributed business transaction may be presented graphically, for example as a hierarchical call graph. Within that graphical representation, an indicator may be provided that represents a portion of code that is causing poor performance. Automatically, or in response to user input, the present system may provide new code which may be used to replace the portion of code that is causing the problem. In some instances, the retrieved code is provided to a user through a code editor, edited by the user, and then transmitted from a server to an agent on the machine that is experiencing the issue. The agents may receive the code, compile the code during runtime (i.e., during the user session currently being monitored), and replace the portion of code causing the performance issue with the newly generated code.

An embodiment may include a method for monitoring and modifying a distributed business transaction. The method begins with monitoring a distributed business transaction performed over a plurality of machines, wherein the distributed business transaction performed by one or more applications on each of the plurality of machines, and the monitoring performed by one or more agents on each of the plurality of machines. The method may continue with identifying a portion of code to be replaced at one of the plurality of machines that executes the distributed business transaction while the distributed business transaction is executing, one of the applications including the portion of code. The portion of code may be replaced at the machine with new code while the distributed business transaction is executing.

An embodiment may include a system for monitoring and modifying a distributed business transaction. The system may include a processor, memory, and one or more modules stored in memory and executable by the processor. When executed, the modules may monitor a distributed business transaction performed over a plurality of machines, the distributed business transaction performed by one or more applications on each of the plurality of machines, the monitoring performed by one or more agents on each of the plurality of machines, identify a portion of code to be replaced at one of the plurality of machines that executes the distributed business transaction while the distributed business transaction is executing, one of the applications including the portion of code, and replace the portion of code at the machine with new code while the distributed business transaction is executing.

### BRIEF DESCRIPTION OF THE DRAWINGS

FIG. 1 is a block diagram of a system for monitoring and correcting performance of a distributed business transaction.

FIG. 2 is a block diagram of a controller.

FIG. 3 is a method for monitoring and correcting performance of a distributed business transaction.

FIG. 4 is a method for identifying a portion of code to be replaced.

FIG. 5 is a method for replacing a portion of code on application with new code.

FIG. 6 is a method for installing new code by an agent on an application.

FIG. 7 is an illustration of a call graph.

FIG. 8 is a block diagram of a computing environment for implementing the present technology.

### DETAILED DESCRIPTION

Distributed business transactions are monitored and problems associated with poor performance are identified. The problems may be associated with a particular portion of code that makes up one or more applications that perform the distributed business transaction being monitored. Portions of code may be replaced, semi-automatically or automatically, to correct the performance issues, by a tool that corrects detected performance issues in a distributed business transaction being monitored. A distributed business transaction may be presented graphically, for example as a hierarchical call graph. Within that graphical representation, an indicator may be provided that represents a portion of code that is causing poor performance. Automatically, or in response to user input, the present system may provide new code which may be used to replace the portion of code that is causing the problem. In some instances, the retrieved code is provided to a user through a code editor, edited by the user, and then transmitted from a server to an agent on the machine that is experiencing the issue. The agents may receive the code, compile the code during runtime (i.e., during the user session currently being monitored), and replace the portion of code causing the performance issue with the newly generated code.

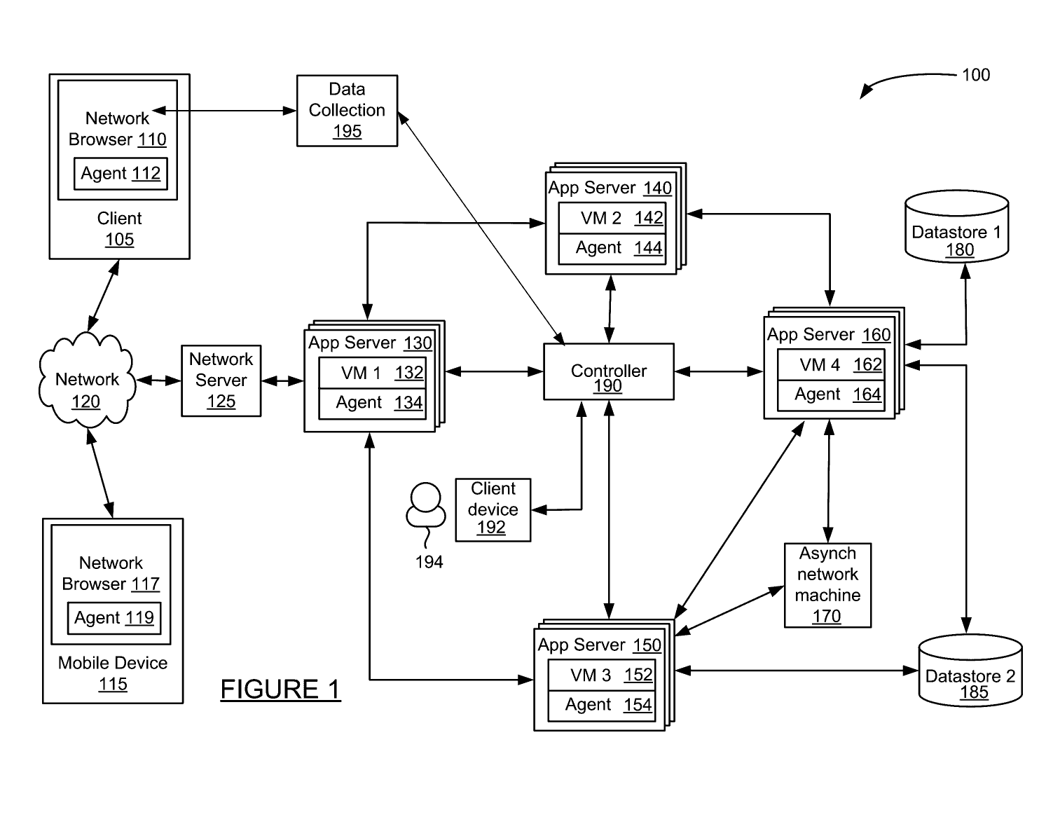

FIG. 1 is a block diagram of a system for monitoring a distributed business transaction. System 100 of FIG. 1 includes client device 105 and 192, mobile device 115, network 120, network server 125, application servers 130, 140, 150 and 160, asynchronous network machine 170, data stores 180 and 185, controller 190, and data collection server 195.

Client device 105 may include network browser 110 and be implemented as a computing device, such as for example a laptop, desktop, workstation, or some other computing device. Network browser 110 may be a client application for viewing content provided by an application server, such as application server 130 via network server 125 over network 120.

Network browser 110 may include agent 112. Agent 112 may be installed on network browser 110 and/or client 105 as a network browser add-on, downloading the application to the server, or in some other manner. Agent 112 may be executed to monitor network browser 110, the operation system of client 105, and any other application, API, or other component of client 105. Agent 112 may determine network browser navigation timing metrics, access browser cookies, monitor code, and transmit data to data collection 160, controller 190, or another device. Agent 112 may perform other operations related to monitoring a request or a network at client 105 as discussed herein.

Mobile device 115 is connected to network 120 and may be implemented as a portable device suitable for sending and receiving content over a network, such as for example a mobile phone, smart phone, tablet computer, or other portable device. Both client device 105 and mobile device 115 may include hardware and/or software configured to access a web service provided by network server 125.

Mobile device 115 may include network browser 117 and an agent 119. Mobile device may also include client applications and other code that may be monitored by agent 119. Agent 119 may reside in and/or communicate with network browser 117, as well as communicate with other applications, an operating system, APIs and other hardware and software on mobile device 115. Agent 119 may have similar functionality as that described herein for agent 112 on client 105, and may repot data to data collection server 160 and/or controller 190.

Network 120 may facilitate communication of data between different servers, devices and machines of system 100 (some connections shown with lines to network 120, some not shown). The network may be implemented as a private network, public network, intranet, the Internet, a cellular network, Wi-Fi network, VoIP network, or a combination of one or more of these networks. The network 120 may include one or more machines such as load balance machines and other machines.

Network server 125 is connected to network 120 and may receive and process requests received over network 120. Network server 125 may be implemented as one or more servers implementing a network service, and may be implemented on the same machine as application server 130 or one or more separate machines. When network 120 is the Internet, network server 125 may be implemented as a web server.

Application server 130 communicates with network server 125, application servers 140 and 150, and controller 190. Application server 130 may also communicate with other machines and devices (not illustrated in FIG. 1). Application server 130 may host an application or portions of a distributed application. The host application 132 may be in one of many platforms, such as including a Java, PHP, .Net, and Node.JS, be implemented as a Java virtual machine, or include some other host type. Application server 130 may also include one or more agents 134 (i.e. “modules”), including a language agent, machine agent, and network agent, and other software modules. Application server 130 may be implemented as one server or multiple servers as illustrated in FIG. 1.

Application 132 and other software on application server 130 may be instrumented using byte code insertion, or byte code instrumentation (BCI), to modify the object code of the application or other software. The instrumented object code may include code used to detect calls received by application 132, calls sent by application 132, and communicate with agent 134 during execution of the application. BCI may also be used to monitor one or more sockets of the application and/or application server in order to monitor the socket and capture packets coming over the socket.

In some embodiments, server 130 may include applications and/or code other than a virtual machine. For example, server 130 may include Java code, .Net code, PHP code, Ruby code, C code or other code to implement applications and process requests received from a remote source.

Agents 134 on application server 130 may be installed, downloaded, embedded, or otherwise provided on application server 130. For example, agents 134 may be provided in server 130 by instrumentation of object code, downloading the agents to the server, or in some other manner. Agents 134 may be executed to monitor application server 130, monitor code running in a or a virtual machine 132 (or other program language, such as a PHP, .Net, or C program), machine resources, network layer data, and communicate with byte instrumented code on application server 130 and one or more applications on application server 130.

Each of agents 134, 144, 154 and 164 may include one or more agents, such as a language agents, machine agents, and network agents. A language agent may be a type of agent that is suitable to run on a particular host. Examples of language agents include a JAVA agent, .Net agent, PHP agent, and other agents. The machine agent may collect data from a particular machine on which it is installed. A network agent may capture network information, such as data collected from a socket.

Agent 134 may detect operations such as receiving calls and sending requests by application server 130, resource usage, and incoming packets. Agent 134 may receive data, process the data, for example by aggregating data into metrics, and transmit the data and/or metrics to controller 190. Agent 134 may perform other operations related to monitoring applications and application server 130 as discussed herein. For example, agent 134 may identify other applications, share business transaction data, aggregate detected runtime data, and other operations.

An agent may operate to monitor a node, tier or nodes or other entity. A node may be a software program or a hardware component (e.g., memory, processor, and so on). A tier of nodes may include a plurality of nodes which may process a similar business transaction, may be located on the same server, may be associated with each other in some other way, or may not be associated with each other.

A language agent may be an agent suitable to instrument or modify, collect data from, and reside on a host. The host may be a Java, PHP, .Net, Node.JS, or other type of platform. Language agent 220 may collect flow data as well as data associated with the execution of a particular application. The language agent may instrument the lowest level of the application to gather the flow data. The flow data may indicate which tier is communicating which with which tier and on which port. In some instances, the flow data collected from the language agent includes a source IP, a source port, a destination IP, and a destination port. The language agent may report the application data and call chain data to a controller. The language agent may report the collected flow data associated with a particular application to network agent 230.

A network agent may be a standalone agent that resides on the host and collects network flow group data. The network flow group data may include a source IP, destination port, destination IP, and protocol information for network flow received by an application on which network agent 230 is installed. The network agent 230 may collect data by intercepting and performing packet capture on packets coming in from a one or more sockets. The network agent may receive flow data from a language agent that is associated with applications to be monitored. For flows in the flow group data that match flow data provided by the language agent, the network agent rolls up the flow data to determine metrics such as TCP throughput, TCP loss, latency and bandwidth. The network agent may then reports the metrics, flow group data, and call chain data to a controller. The network agent may also make system calls at an application server to determine system information, such as for example a host status check, a network status check, socket status, and other information.

A machine agent may reside on the host and collect information regarding the machine which implements the host. A machine agent may collect and generate metrics from information such as processor usage, memory usage, and other hardware information.

Each of the language agent, network agent, and machine agent may report data to the controller. Controller 210 may be implemented as a remote server that communicates with agents located on one or more servers or machines. The controller may receive metrics, call chain data and other data, correlate the received data as part of a distributed transaction, and report the correlated data in the context of a distributed application implemented by one or more monitored applications and occurring over one or more monitored networks. The controller may provide reports, one or more user interfaces, and other information for a user.

Agent 134 may create a request identifier for a request received by server 130 (for example, a request received by a client 105 or 115 associated with a user or another source). The request identifier may be sent to client 105 or mobile device 115, whichever device sent the request. In embodiments, the request identifier may be created when a data is collected and analyzed for a particular business transaction. Additional information regarding collecting data for analysis is discussed in U.S. patent application no. U.S. patent application Ser. No. 12/878,919, titled “Monitoring Distributed Web Application Transactions,” filed on Sep. 9, 2010, U.S. Pat. No. 8,938,533, titled “Automatic Capture of Diagnostic Data Based on Transaction Behavior Learning,” filed on Jul. 22, 2011, and U.S. patent application Ser. No. 13/365,171, titled “Automatic Capture of Detailed Analysis Information for Web Application Outliers with Very Low Overhead,” filed on Feb. 2, 2012, the disclosures of which are incorporated herein by reference.

Each of application servers 140, 150 and 160 may include an application and agents. Each application may run on the corresponding application server. Each of applications 142, 152 and 162 on application servers 140-160 may operate similarly to application 132 and perform at least a portion of a distributed business transaction. Agents 144, 154 and 164 may monitor applications 142-162, collect and process data at runtime, and communicate with controller 190. The applications 132, 142, 152 and 162 may communicate with each other as part of performing a distributed transaction. In particular each application may call any application or method of another virtual machine.

Asynchronous network machine 170 may engage in asynchronous communications with one or more application servers, such as application server 150 and 160. For example, application server 150 may transmit several calls or messages to an asynchronous network machine. Rather than communicate back to application server 150, the asynchronous network machine may process the messages and eventually provide a response, such as a processed message, to application server 160. Because there is no return message from the asynchronous network machine to application server 150, the communications between them are asynchronous.

Data stores 180 and 185 may each be accessed by application servers such as application server 150. Data store 185 may also be accessed by application server 150. Each of data stores 180 and 185 may store data, process data, and return queries received from an application server. Each of data stores 180 and 185 may or may not include an agent.

Controller 190 may control and manage monitoring of business transactions distributed over application servers 130-160. In some embodiments, controller 190 may receive application data, including data associated with monitoring client requests at client 105 and mobile device 115, from data collection server 160. In some embodiments, controller 190 may receive application monitoring data and network data from each of agents 112, 119, 134, 144 and 154. Controller 190 may associate portions of business transaction data, communicate with agents to configure collection of data, and provide performance data and reporting through an interface. The interface may be viewed as a web-based interface viewable by client device 192, which may be a mobile device, client device, or any other platform for viewing an interface provided by controller 190. In some embodiments, a client device 192 may directly communicate with controller 190 to view an interface for monitoring data.

Client device 192 may include any computing device, including a mobile device or a client computer such as a desktop, work station or other computing device. Client computer 192 may communicate with controller 190 to create and view a custom interface. In some embodiments, controller 190 provides an interface for creating and viewing the custom interface as a content page, e.g., a web page, which may be provided to and rendered through a network browser application on client device 192.

Applications 132, 142, 152 and 162 may be any of several types of applications. Examples of applications that may implement applications 132-162 include a Java, PHP, .Net, Node.JS, and other applications.

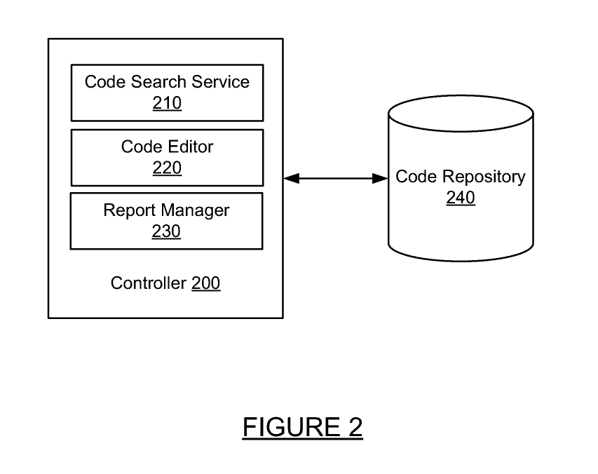

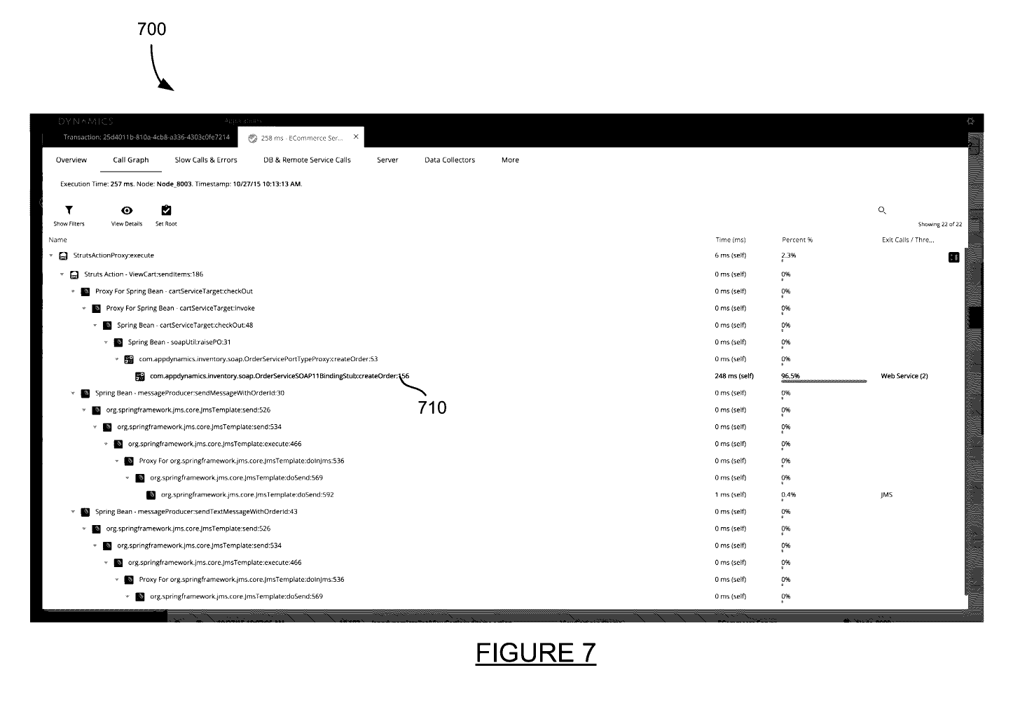

FIG. 2 is a block diagram of a controller. The controller 200 of FIG. 2 may be used to implement controller 190 in the system of FIG. 1. Controller 200 may include a code search service to 210, code editor 220, and report manager 230. Report manager 230 may provide one or more reports based on data collected from one or more agents, such as the agents illustrated in the system of FIG. 1. The report manager may provide a report as a graphical user interface, for example an interface for reporting session data, a call graph, or in some other form. An example of a snapshot is discussed in more detail with respect to U.S. patent application Ser. No. 14/814,762, filed on Jul. 31, 2015, titled “Monitoring a Network Session,” the disclosure of which is incorporated herein by reference. A call graph may include a hierarchical representation of objects and calls that are used to implement a distributed business transaction. An example of a call graph is illustrated in FIG. 7. Within the call graph, an indicator may be provided that represents a portion of code that is performing poorly. Upon selecting the indicator, user may elect to replace the portion of code that is performing poorly, such as for example by a pop window, or via a code editor that is generated and populated with proposed replacement code.

Upon receiving input to change the portion of code associated with the indicator, such as for example an indicator within a call graph, code search service 210 may retrieve a new code file which will ultimately replace the portion of code identified in the call graph. Code search service 210 may retrieve a new file of code from code repository 240 based on parameters of the identified code. The parameters of the identified code may include an object type, class type, location to be replaced, and other data that identifies the code to be replaced. Code repository 240 may be remote from controller 200 as illustrated in FIG. 2 or may be hosted within controller 200.

Code editor 220 accesses the retrieved code and provides the code to an administrator for editing. Within the code editor, an administrator may review the proposed new code file, modify it if desired, and submit the new code to be packaged and transmitted to a particular machine or node. A node may include one or more machines having the same applications which provide the same functionality. In some instances, the user need not edit the code, and code editor 220 simply packages the code for transport to an agent on the machine at which the identify portion of code which is performing badly is located.

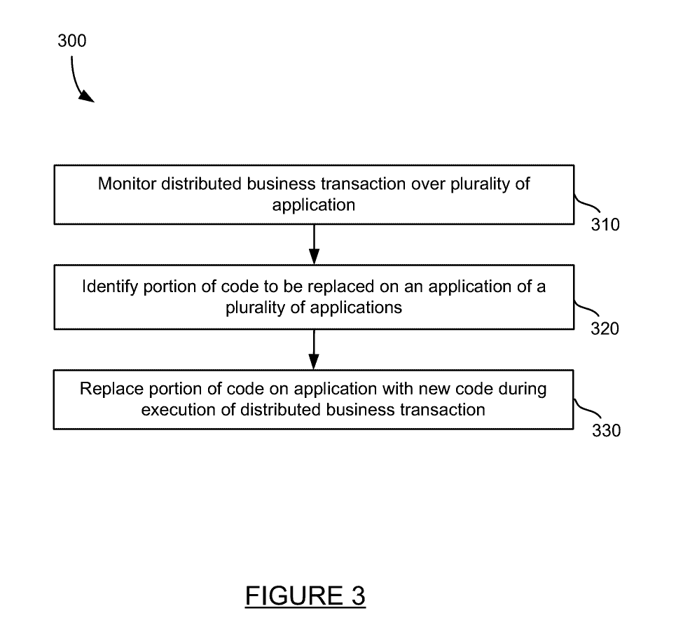

FIG. 3 is a method for monitoring and correcting performance of a distributed business transaction. First, a distributed business transaction is monitored over a plurality of applications at step 310. A distributed business transaction may be monitored by one or more agents on each machine at which a distributed business transaction occurs. Each agent may monitor one or more applications on each machine, the machine itself, and the network resources used by the distributed application.

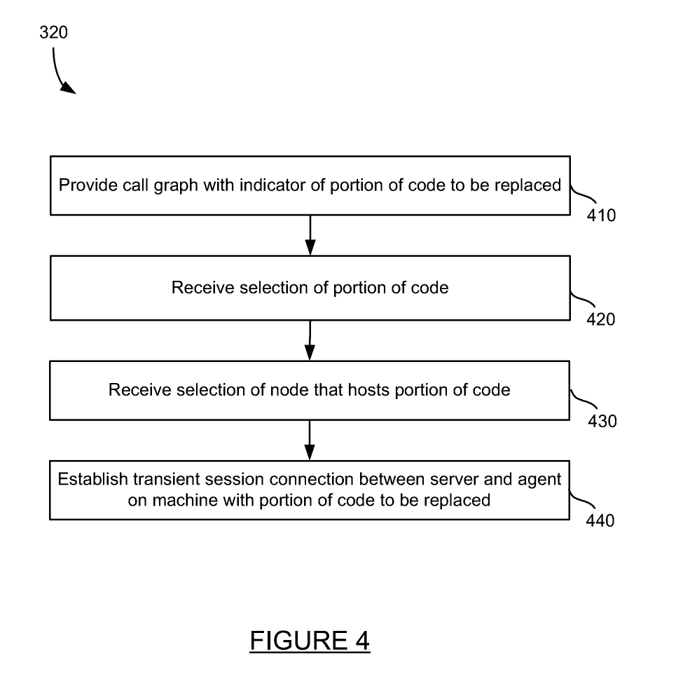

Portions of code to be replaced on an application of a plurality of applications are identified at step 320. Identifying a portion of code may be performed automatically, such as by identifying portions of an application that are performing poorly, or in response to user input. Poorly performing code portions may be identified, for example, by comparing code performance to a baseline developed over a period of time. More detail for identifying a portion code to be replaced is discussed below with respect to the method of FIG. 4.

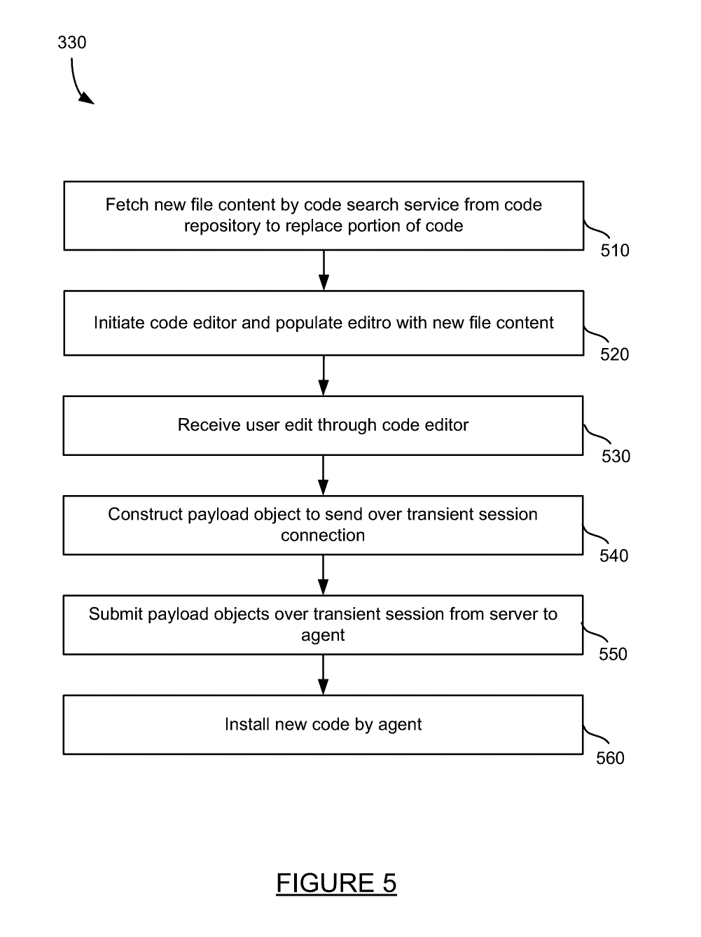

A portion of code on an application is replaced with new code at step 330. The portion of code may be replaced during execution of the distributed business transaction (during a user session in which the distributed business transaction is handling a user request). As such, there is no need for taking one or more applications or machines offline to replace code. Rather, such as for example in a Java environment, the new code is replaced during runtime by agents located on that machine. This provides for an expedited code update process, one does not require bringing machines down or offline and thereby causing delays or performance issues. Replacing a portion of code on an application with new code during execution of the distributed business transaction is discussed in more detail below with respect to the method of FIG. 5.

FIG. 4 is a method for identifying a portion of code to be replaced. FIG. 4 provides more detail for step 320 of the method of FIG. 3. First, a call graph with an indicator of the portion of code to be replaced is provided to a user at step 410. The call graph may be provided through a graphical user interface is provided by the controller. An example of a call graph with in indicator for code to be replaced is discussed with respect to FIG. 7.

Next, a selection of the portion of code is received at step 420. In instances where the code replacement is performed at least in part on user input, a user may select an indicator for the portion of code that is performing poorly. In some instances, there may be several indicators relating to several portions of code and a call graph that may be replaced by the present system. In instances where the replacement is done automatically, the selection of a portion of code is done automatically by logic contained in the controller. For example, the logic may involve selecting the worst-performing code to correct based on a baseline, threshold or other parameters, portions of code that are simple to replace, or other portions of code for replacement based on designer preference.

A selection of a node that hosts the particular portion of code is received at step 430. In some instances, a call graph may provide an aggregated representation of the business transaction. The aggregated representation may generalize the performance of a portion of code to be replaced over several tears or machines. As such, a particular machine or tier may be selected at which the portion of code is to be replaced. Once the code and node are selected, a transient session connection is established between a controller (i.e., a remote server) and an agent on the machine with the portion of code to be replaced. The transient session may be initiated by either the controller or the agent.

FIG. 5 is a method for replacing a portion of code on application with new code. The method of FIG. 5 provides more detail for step 330 of the method of FIG. 3. First, new file content (i.e., new code) is fetched by a code search service from a code repository to replace a portion of code at step 510. The new file content is selected based on parameters associated with the code to be replaced. The parameters may include an object type, class type, version, location of code, and other parameters. A code editor is initiated and populated with the new file content at step 520. The populated code editor may then be provided to a user, and user edits may be received through the code editor at step 530. The user may edit the populated code to make any desired changes to the code. In some instances, wherein the code replacement is automatic, the code editor automatically creates the payload object and continues to step 540 from step 520.

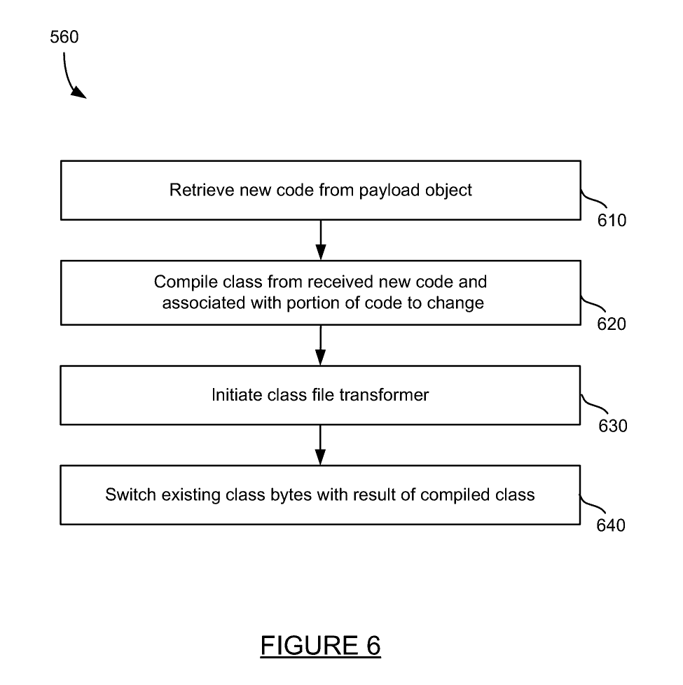

A payload object is constructed to transmit over a transient session connection from a controller to an agent at step 540. The payload objects are then submitted over the transient session by the server to the agent at step 560. The payload object is received by the agent and installed at step 560. Installing the code by the agent may include compiling the code and switching the compiled code with the existing code. Installing the new code by the agent is discussed in more detail below with respect to the method of FIG. 6.

FIG. 6 is a method for installing new code by an agent on an application. FIG. 6 provides more detail for step 560 if the method of FIG. 5. First, new code is retrieved from the payload object at step 610. A class is compiled by the agent from the received new code at step 620. The compiled class may be associated with a portion of code to change with the compiled new code. A class file transformer is initiated at step 630, and the existing class bytes are switched with the result of the compiled class at step 640. After the switch, the selected portion of code is replaced with the newly compiled code. The replacement occurs during the user session associated with the distributed business transaction, such as for example during Runtime in a Java environment. As such, subsequent monitoring of the application, including additional monitoring of the current user session, will be based on the new code inserted within the application.

FIG. 7 is an illustration of a call graph. Call graph 700 is a hierarchical representation of the calls that make up a distributed business transaction. Information provided in the call graph includes the object called, the time taken by the object to execute, the percentage of the total time taken by the object, and other data. As shown, the object 710 took 248 seconds to execute and was 96.5% of the time for the distributed business transaction. An indicator in the form of a highlight bar is placed on the object within the call graph. When the indicator (highlight bar) is selected by a user, a code editor may appear with a proposed code change to fix the object causing the delay in the distributed business transaction.

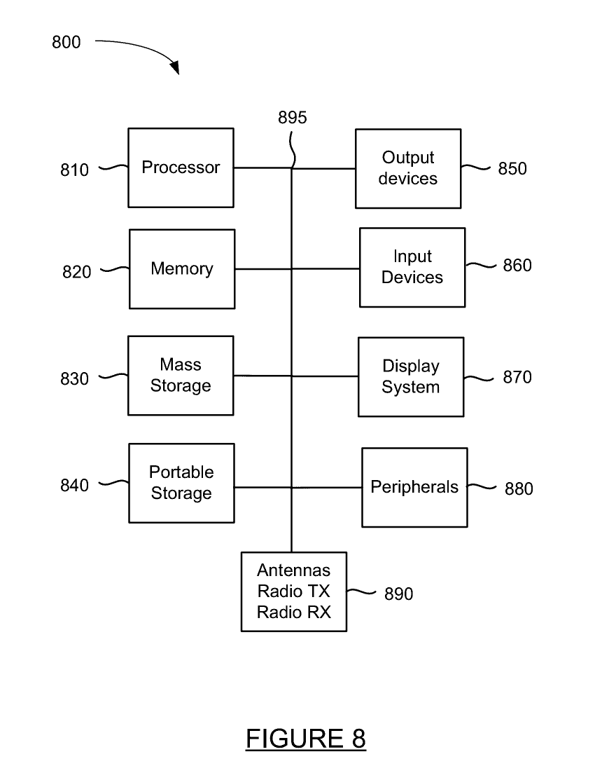

FIG. 8 is a block diagram of a system for implementing the present technology. System 800 of FIG. 8 may be implemented in the contexts of the likes of client computer 105 and 192, servers 125, 130, 140, 150, and 160, machine 170, data stores 180 and 190, and controller 190. The computing system 800 of FIG. 8 includes one or more processors 810 and memory 820. Main memory 820 stores, in part, instructions and data for execution by processor 810. Main memory 820 can store the executable code when in operation. The system 800 of FIG. 8 further includes a mass storage device 830, portable storage medium drive(s) 840, output devices 850, user input devices 860, a graphics display 870, and peripheral devices 880.

The components shown in FIG. 8 are depicted as being connected via a single bus 890. However, the components may be connected through one or more data transport means. For example, processor unit 810 and main memory 820 may be connected via a local microprocessor bus, and the mass storage device 830, peripheral device(s) 880, portable storage device 840, and display system 870 may be connected via one or more input/output (I/O) buses.

Mass storage device 830, which may be implemented with a magnetic disk drive, an optical disk drive, a flash drive, or other device, is a non-volatile storage device for storing data and instructions for use by processor unit 810. Mass storage device 830 can store the system software for implementing embodiments of the present invention for purposes of loading that software into main memory 820.

Portable storage device 840 operates in conjunction with a portable non-volatile storage medium, such as a floppy disk, compact disk or Digital video disc, USB drive, memory card or stick, or other portable or removable memory, to input and output data and code to and from the computer system 800 of FIG. 8. The system software for implementing embodiments of the present invention may be stored on such a portable medium and input to the computer system 800 via the portable storage device 840.

Input devices 860 provide a portion of a user interface. Input devices 860 may include an alpha-numeric keypad, such as a keyboard, for inputting alpha-numeric and other information, a pointing device such as a mouse, a trackball, stylus, cursor direction keys, microphone, touch-screen, accelerometer, and other input devices Additionally, the system 800 as shown in FIG. 8 includes output devices 850. Examples of suitable output devices include speakers, printers, network interfaces, and monitors.

Display system 870 may include a liquid crystal display (LCD) or other suitable display device. Display system 870 receives textual and graphical information, and processes the information for output to the display device. Display system 870 may also receive input as a touch-screen.

Peripherals 880 may include any type of computer support device to add additional functionality to the computer system. For example, peripheral device(s) 880 may include a modem or a router, printer, and other device.

The system of 800 may also include, in some implementations, antennas, radio transmitters and radio receivers 890. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth devices, and other radio frequency networks. The devices may include one or more radio transmitters and receivers for processing signals sent and received using the antennas.

The components contained in the computer system 800 of FIG. 8 are those typically found in computer systems that may be suitable for use with embodiments of the present invention and are intended to represent a broad category of such computer components that are well known in the art. Thus, the computer system 800 of FIG. 8 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, iOS, Android, C, C++, Node.JS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for monitoring and modifying a distributed business transaction, comprising:
monitoring a distributed business transaction performed over a plurality of machines, the distributed business transaction performed by one or more applications on each of the plurality of machines, the monitoring performed by one or more agents on each of the plurality of machines;
identifying a portion of code to be replaced at one of the plurality of machines that executes the distributed business transaction while the distributed business transaction is executing, one of the applications including the portion of code; and
replacing the portion of code at the machine with new code while the distributed business transaction is executing.

2. The method of claim 1, further comprising providing a call graph for the distributed business transaction, the call graph indicating the portion of code to be replaced.

3. The method of claim 1, further comprising establishing a connection between a server and the machine that includes the portion of code, the new code transmitted from the server to the machine through the connection

4. The method of claim 3, wherein the connection is a transient session established during runtime while the machine is providing a user session.

5. The method of claim 1, wherein identifying includes receiving a selection of the portion of code from a user.

6. The method of claim 1, wherein identifying includes automatically generating the new code in response to identifying the portion of code.

7. The method of claim 1, further comprising:
providing a code editor;
populating new code retrieved based on the identified portion of code; and
receiving a user input to change the portion of code with the populated new code.

8. The method of claim 1, further replacing includes constructing class path bits during Runtime

9. The method of claim 1, further replacing includes:
compiling a class based on the new code and associated with the portion of code; and
replacing the portion of code with the compiled class.

10. A non-transitory computer readable storage medium having embodied thereon a program, the program being executable by a processor to perform a method for monitoring and modifying a business transaction, the method comprising:
monitoring a distributed business transaction performed over a plurality of machines, the distributed business transaction performed by one or more applications on each of the plurality of machines, the monitoring performed by one or more agents on each of the plurality of machines;
identifying a portion of code to be replaced at one of the plurality of machines that executes the distributed business transaction while the distributed business transaction is executing, one of the applications including the portion of code; and
replacing the portion of code at the machine with new code while the distributed business transaction is executing.

11. The non-transitory computer readable storage medium of claim 10, further comprising providing a call graph for the distributed business transaction, the call graph indicating the portion of code to be replaced.

12. The non-transitory computer readable storage medium of claim 10, further comprising establishing a connection between a server and the machine that includes the portion of code, the new code transmitted from the server to the machine through the connection

13. The non-transitory computer readable storage medium of claim 12, wherein the connection is a transient session established during runtime while the machine is providing a user session.

14. The non-transitory computer readable storage medium of claim 10, wherein identifying includes receiving a selection of the portion of code from a user.

15. The non-transitory computer readable storage medium of claim 10, wherein identifying includes automatically generating the new code in response to identifying the portion of code.

16. The non-transitory computer readable storage medium of claim 10, further comprising:
providing a code editor;
populating new code retrieved based on the identified portion of code; and
receiving a user input to change the portion of code with the populated new code.

17. The non-transitory computer readable storage medium of claim 10, further replacing includes constructing class path bits during Runtime

18. The non-transitory computer readable storage medium of claim 10, further replacing includes:
compiling a class based on the new code and associated with the portion of code; and
replacing the portion of code with the compiled class.

19. A system for monitoring and modifying a business transaction, comprising:
a server including a memory and a processor; and
one or more modules stored in the memory and executed by the processor to monitor a distributed business transaction performed over a plurality of machines, the distributed business transaction performed by one or more applications on each of the plurality of machines, the monitoring performed by one or more agents on each of the plurality of machines, identify a portion of code to be replaced at one of the plurality of machines that executes the distributed business transaction while the distributed business transaction is executing, one of the applications including the portion of code, and replace the portion of code at the machine with new code while the distributed business transaction is executing.

20. The system of claim 19, the one or more modules further executable to provide a call graph for the distributed business transaction, the call graph indicating the portion of code to be replaced.

21. The system of claim 19, the one or more modules further executable to establish a connection between a server and the machine that includes the portion of code, the new code transmitted from the server to the machine through the connection

22. The system of claim 21, wherein the connection is a transient session established during runtime while the machine is providing a user session.

23. The system of claim 19, wherein identifying includes receiving a selection of the portion of code from a user.

24. The system of claim 19, wherein identifying includes automatically generating the new code in response to identifying the portion of code.

25. The system of claim 19, the one or more modules further executable to provide a code editor, populate new code retrieved based on the identified portion of code, and receive a user input to change the portion of code with the populated new code.

26. The system of claim 19, wherein replacing includes constructing class path bits during Runtime

27. The system of claim 19, wherein replacing includes compiling a class based on the new code and associated with the portion of code and replacing the portion of code with the compiled class.
